(19) United States
(12) Patent Application Publication
(10) Pub. No.: US 2018/0273879 A1
(43) Pub. Date: Sep. 27, 2018

(54) Natural oils scent cover mixture

(71) Applicant: Bradley Kyle Craig, Choctaw, OK (US)

(72) Inventor: Bradley Kyle Craig, Choctaw, OK (US)

(21) Appl. No.: 15/932,583

(22) Filed: Mar. 16, 2018

Related U.S. Application Data
(60) Provisional application No. 62/601,463, filed on Mar. 22, 2017.

(51) Int. Cl. C11B 9/00

(52) U.S. Cl. CPC C11B 9/00

(57) ABSTRACT

A natural oil cover scent mixture containing a mixture of a base oil and a strong fragrance oil, cloaks and masks the odor of a hunter from detection by game animals being hunted, consisting primarily of a mixture of natural and beneficial topical oils, preferably jojoba oil, and a strong natural oil, primarily a cedar oil.

### CROSS REFERENCE TO RELATED APPLICATIONS

Applicant claims the benefit of Provisional Application No. 62/601,463, filed by the same inventor on Mar. 22, 2017.

### I. BACKGROUND OF THE INVENTION

### 1. Field of Invention

A natural oil cover scent mixture containing a mixture of a base oil and a strong fragrance oil, cloaks and masks the odor of a hunter from detection by game animals being hunted, consisting primarily of a mixture of natural and beneficial topical oils, preferably jojoba oil, and a strong natural oil, primarily a cedar oil.

### 2. Description of Prior Art

A preliminary review of prior art patents was conducted by the applicant which reveal prior art patents in a similar field or having similar use. However, the prior art inventions do not disclose the same or similar elements as the present cover scent, nor do they present the material components in a manner contemplated or anticipated in the prior art.

Several products use natural tree and forest timber oil for various purposes, especially cedar oil, known for its various repellant character to insects and covering scent. In U.S. Pat. No. 9,480,251 to Walter, cedar oil and geraniol are mixed for use as a natural pesticide. In U.S. Pat. No. 9,326,524 to Jack, cedar oil, along with geranium oil, peppermint oil, rosemary oil, and lavender oil with water, vegetable glycerin or isopropyl alcohol and several other ingredients are combined t repel insects on animals and humans. A cedar oil evaporator is disclosed in U.S. Pat. No. 7,798,422 to Trevino. A moth and insect repellant using cedar oil is disclosed in U.S. Pat. No. 6,251,431 to Van Ross, U.S. Pat. No. 5,320,066 to Gunter, and also in U.S. Pat. No. 6,231,865 to Hsu. Cedar oil was not disclosed as a cover scent for hunters in prior art.

### II. SUMMARY OF THE INVENTION

Wild game is known to have a heightened sense of smell and in their natural habitat, tend to smell humans and human odors from far off distances and are repelled. They also tend to smell potential mates of their same species, which causes them to be attracted and drawn toward the source of the odors. Thus, two types of scents are used by hunters in their quest for wild game - luring scents, to draw the game close to a selected hunting area, and cover scents, to prevent the wild game from detecting the smell of a human hunter. The subject of the present cover scent is to mask and cloak the smell of the hunter by use of natural oils which may be used topically on the skin as a deodorant, on clothing, other body odors or to mask other remnant odors where a hunter has been.

### III. DESCRIPTION OF THE DRAWINGS

No drawings submitted.

### IV. DESCRIPTION OF THE PREFERRED EMBODIMENT

A natural cover scent made of bodily contact safe beneficial natural oils and a strong scented oil is used as a cover scent for hunters. Previous cover scents have been applied to pads, clothing or boots, or scent distributors. The present cover scent may be applied to not only the same items as those previously used, but to the actual hunter themselves.

The present cover scent blends skin healthy natural base oils along with fragrance oils having a strong natural scent which covers the natural smell of a hunter. There are several beneficial natural base oils which are used in skin care that provide benefit for the skin, even the sensitive skin in the face and neck, which are provided as the base oil of the cover scent as well as a non-consumable oral rinse to cover breath emissions. Those natural beneficial base oils include, but are not limited to, alfalfa oil extracts, argan oil, almond oil, avocado oil, coconut oil, eucalyptus oil, flaxseed oil, grapeseed oil, geranium oil, jojoba oil, lavender oil, olive oil, peanut oil, pecan oil, rose hip oil, sage oil and safflower oil. It is preferred that each of these oils be clarified so that they do not stain skin or clothing. These natural oils have been used in skin care products for topical application to skins to enhance skin and also eliminate skin disorders and will also serve as an oral rinse, although they are not recommended for ingestion. Of these natural oils, jojoba has shown to be closest to the natural oils produced by the body and therefore preferable in the present cover scent. Jojoba also presents a neutral base which does not overpower the intended strong scent combined without imparting its own smell to the cover scent, for which the beneficial base oils are not intended. It is within the scope of this cover scent that certain beneficial oils could provide some degree of attraction to wild game, some of which are known to prefer sweet smells to which the coconut oils and almond oils could prove desirable.

The strong natural fragrance oils also provide an extensive list of possible combinations. These have been used in fragrance dispensers for household use, in odor masking scent sprays, cooking enhancement, spices and in recipes, cosmetics, personal hygiene products, for aroma therapy, candle making and other uses for which a strong scent would be appropriate. However for hunting purposes, it is most preferable to either provide a scent common to the hunting area and geographical location, or one that is known to distract wild game over the smell of a human hunter. In this regard, since a great deal of hunting is conducted in wooded areas where conifers are known to exist, the present invention prefers a strong cedar oil mixed with the jojoba oil for its cover scent mixture. The cedar oil has been demonstrated to emit a cedar dominant fragrance producing an unexpected combined result of being both topically safe to human skin and non-toxic, having been used in soaps, sprays and deodorants as well as internally safe in the event of incidental consumption. Other strong fragrant natural oils include other conifer oils including pine, spruce and fur, but several of these have resulted in allergic indications, with cedar oil considered generally safe by the FDA as a food additive, an antibacterial and fungicide, and insecticide when used with moderate exposure and limited intentional consumption.

Other fragrance oils can include not only those listed above, in which instance a single oil could serve as both the fragrance and the base oils, including but not limited to amber, apple, apricot, blackberry, blueberry, cinnamon leaf, cranberry, cut grass, dirt, grapefruit, grape, lavender, leather, lilac, lemon, lemon grass, lime, myrrh, oak, oak moss, patchouli, pine, plum, rosemary, orange, sandlewood, tangerine, tea tree, and other herbal oils. It is the fragrance oil that must dominate the smell, although the base oil can provide additional fragrance. Keeping in mind the primary purpose of this natural cover scent is to cover and mask the smell of the hunter, it can be a secondary benefit if the selected blended scents also provide some attraction to the hunted game.

In certain instances, a natural food coloring or pigment may be added without affecting the oil mixture. The mixture may also provide a liquid neutral delivery which provides some degree of dilution, but also provides the oil mixture with a more flowable matrix for spray application to skin, clothing or as an oral rinse by pump or aerosol. Some variations of cover scent may include more than one strong fragrance scent, more than one beneficial base oil, or more than one of each in combination. Although the embodiments of the natural cover scent oil mixtures have been described and shown above, it will be appreciated by those skilled in the art that numerous modifications may be made therein without departing from the scope of the invention as herein described.

What is claimed is:

1. A natural cover scent mixture made of bodily contact safe beneficial natural oils and a strong scented oil used as a cover scent for hunters, said natural cover scent mixture comprising:
a quantity of a natural base oil which is applied topically on the skin or used as a non-consumable oral rinse which is beneficial and non-irritating to the skin;
a quantity of a natural fragrance oil providing a strong scent common to the hunting area and geographical location, or one that is known to distract wild game over the smell of a human hunter; and
a quantity of a neutral delivery liquid for spray application by pump or aerosol spray where indicated appropriate for delivery purposes.

2. The natural cover scent of claim 1, further comprising:
said natural base oil is one or more oils selected from a list of natural oils including but not limited to clarified alfalfa oil extracts, argan oil, almond oil, avocado oil, coconut oil, eucalyptus oil, flaxseed oil, grapeseed oil, geranium oil, jojoba oil, lavender oil, olive oil, peanut oil, pecan oil, rose hip oil, sage oil and safflower oil or other natural oils which are beneficial to the skin and suitable as a non-consumable oral rinse.

3. The natural cover scent of claim 1, further comprising:
said natural fragrance oil is one or more oils selected from a list of natural oils including but not limited to amber, apple, apricot, blackberry, blueberry, cinnamon leaf, cedar, cranberry, cut grass, dirt, grapefruit, grape, lavender, leather, lilac, lemon, lemon grass, lime, myrrh, oak, oak moss, patchouli, pine, plum, rosemary, orange, sandlewood, tangerine, tea tree, and other herbal oils, preferably excluding mint scents.

4. The natural cover scent of claim 1, further comprising:
said natural base oil is jojoba oil; and
said natural fragrance oil is cedar oil.

5. The natural cover scent of claim 1, further comprising any other combination of elements as disclosed within the specification.
